(19) United States
(12) Patent Application Publication
(10) Pub. No.: US 2003/0152264 A1
(43) Pub. Date: Aug. 14, 2003

(54) Method and system for processing stereoscopic images

(76) Inventor: Christopher H. Perkins, Westlake Village, CA (US)

Correspondence Address: Christopher H. Perkins, 179 Via Colinas, Westlake Village, CA, 91362, US

(21) Appl. No.: 10/364,733

(22) Filed: Feb. 11, 2003

Related U.S. Application Data
(60) Provisional application No. 60/356,362, filed on Feb. 13, 2002.

(51) Int. Cl. G06K 9/00

(52) U.S. Cl. 382/154

(57) ABSTRACT

A method and system for processing stereoscopic images includes a computer program operable to acquire stereoscopic data from image sensors. The computer program is further operable to process the stereoscopic data from image sensors into output that can be satisfactorily resolved by human vision.

### RELATED APPLICATION

This application claims priority from U.S. Provisional Application Serial No. 60/356,362, filed Feb. 13, 2002.

### BACKGROUND OF THE INVENTION

This invention relates generally to the field of computer graphics. More particularly the present invention relates to a method and system for processing stereoscopic images.

Methods for creating stereoscopic photographs are well known. Typically these methods image a three dimensional subject by way of special cameras that record a subject on one or more frames of photosensitive films that are subsequently developed, printed, and mounted for display. The configurations of these cameras vary in their design as does the resulting format of the stereoscopic images produced by these cameras. One style consists of a camera body fitted with two lenses aligned at a fixed interocular distance. Another configuration consists of two separate cameras mounted on tripods or a single bar that provides alignment and variable spacing of the interocular distance. Yet another style consists of a camera with a single lens that is fitted with a stereoscopic image splitter. In this configuration the image splitter consists of mirrors in the optical path that reflect a left and right image to a single lens through which a single frame of photosensitive emulsion is exposed. All of these configurations create images of various formats that must at some point be aligned or mounted in relation to one another to be satisfactorily resolved by human vision.

In humans of normal physiology, the precise, side-by-side alignment of the right and left eyes provides registration of the two images cast on the retina and the brain's subsequent “fusing” of the images that results in the perception of a unified external reality with depth. Stereoscopic photography achieves its life-like depth and realism by mimicking this fusion characteristic of human vision by presenting two aligned, horizontally offset images of a subject to the eyes. However, the brain's processing of vision is extremely sensitive to the alignment of left and right images presented to the eyes. Distortions or the inability to resolve a stereoscopic image can result from small deviations of the alignment, rotation, and scaling of the two images in relation to one another. Thus, the creation of satisfactory stereoscopic image output depends in large measure on the proper alignment and position of the displayed images in relation to one another. Typically, stereoscopic images created on film emulsions are manually aligned in a mount or manually printed in formats of various types. These manual methods require tedious and time-consuming adjustments to achieve image positioning satisfactory for resolution by human vision. As a result, the creation of customized stereoscopic portraits of subjects in a commercial or retail workflow environment is resistant to automated production processes.

In an effort to overcome these disadvantages, the possibility of using digital cameras to acquire stereoscopic images presents new opportunities for the creation of custom stereoscopic portraits in commercial and retail settings. The ability to by-pass the use of film emulsions and download an image from a digital camera to a computer suggests the possibility of improved workflow speeds. Furthermore, digital processing allows for adjustment and alignment of stereoscopic images in a computer graphics application.

One adjustment includes positioning of an acquired stereoscopic image pair in relation to another stereoscopic image pair for superimposition or compositing. Another adjustment includes correcting the relationship of the left and right images of a stereoscopic pair as a result of misaligned cameras, image splitters, and other acquisition methods. However, none of the existing computer graphics programs and systems offer the required functionality specific to the acquisition, processing, formatting and output of stereoscopic images.

Accordingly, there is a continuing need for a method of creating stereoscopic images which can be resolved by human vision in a much less time-consuming and tedious manner than manual methods. What is also needed is a method for creating such stereoscopic images which lends itself to being used in the commercial or retail work flow environment so as to be automated. What is further needed is such a method which implements computer processing to achieve these needs. The present invention fulfills these needs and provides other related advantages.

### SUMMARY OF THE INVENTION

The present invention comprises a method and system for the processing of stereoscopic images. According to a preferred embodiment of the invention, a method for acquiring, processing, aligning, positioning, displaying and printing of stereoscopic images utilizes a computer program. The computer program is operable to acquire stereoscopic data from image sensors. The computer program is further operable to process stereoscopic data from image sensors into output that can be displayed and printed in a manner satisfactory for resolution by human vision. The invention provides several technical advantages. Stereoscopic images may be processed more accurately and workflow speeds significantly increased.

The process of the present invention generally comprises the steps of providing two images in at least one digital image array. An image sensor is used to acquire the at least one digital image array. The image sensor may comprise a plurality of image sensors, typically two, positioned relative to one another to capture the images in at least one digital image array. Alternatively, an image splitting device is associated with a single image sensor for creating left and right images. The at least one digital image array which has been acquired from the one or more image sensors is then electronically transferred to a storage medium. Utilizing a computerized system operably connected to the storage medium, the images are selectively retrieved and at least one of the images is manipulated such that a stereoscopic effect is created that can be resolved by human vision.

Such manipulation means include image transform where the user selects a pixel coordinate in one image array and a pixel coordinate in a second image array. A new, identical frame boundary is established for each of the image arrays based upon a relationship to the selected pixel coordinates. Further processing includes the assignment of left or right position to the two image arrays in their relationship as a stereoscopic image pair. Additionally, there is processing for the alignment and position of each image's x and y image dimensions in relation to one another so that, for example, the proper interocular spacing of the two image arrays for output and subsequent viewing can be executed. Another embodiment includes a method whereby a single image array acquired, for example, by a stereoscopic image splitter is divided into two discrete arrays for subsequent independent or dependent transform (i.e. rotation, scaling, cropping, translation, constraint, etc.) and positioning of the two image arrays.

After the images have been divided, copied, assigned left and right positions, properly aligned, cropped, scaled, divided, etc., they are displayed, typically by presenting them on an electronic screen, or printing the stereoscopic images.

Another technical advantage of the invention includes the integration of its capabilities into existing computer graphics programs developed by third parties, addressing particular markets. In one embodiment, the invention provides the processing for a stereoscopic image of a subject that is then superimposed into a pre-existing stereoscopic background scene and composited for output by a third-party computer graphics program.

A further technical advantage of the invention is the ability to create pre-set formats that execute multiple transforms on image pairs by a single action by a user and thus result in the development of simpler, more automated workflow processes for faster customer service and less training of personnel.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

For a more complete understanding of the present invention and the advantages thereof, reference is now made to the following descriptions taken in connection with the accompanying drawings in which:

FIG. 1 is a schematic block diagram illustrating a computer graphics system used in accordance with the present invention for processing stereoscopic images;

FIG. 2 is a schematic block diagram illustrating the creation of stereoscopic images resolvable by the human eye utilizing the computer graphics system of FIG. 1 and multiple image sensors;

FIG. 3 is a schematic block diagram illustrating manipulating or transform processes in creating the stereoscopic images;

FIG. 4 is a schematic block diagram illustrating the creation of stereoscopic images resolvable by the human eye utilizing the computer graphics system of FIG. 1, and a single image sensor incorporating an image splitter;

FIG. 5 is a schematic block diagram illustrating the transforming or manipulating steps to create such images utilizing the image splitter; and

FIG. 6 is a flow chart illustrating the steps taken in accordance with the present invention.

### DETAILED DESCRIPTION OF THE PREFERRED EMBODIMENTS

The present invention resides in a process for creating stereoscopic images which are resolvable by human vision and which can be used in an automated and commercial setting.

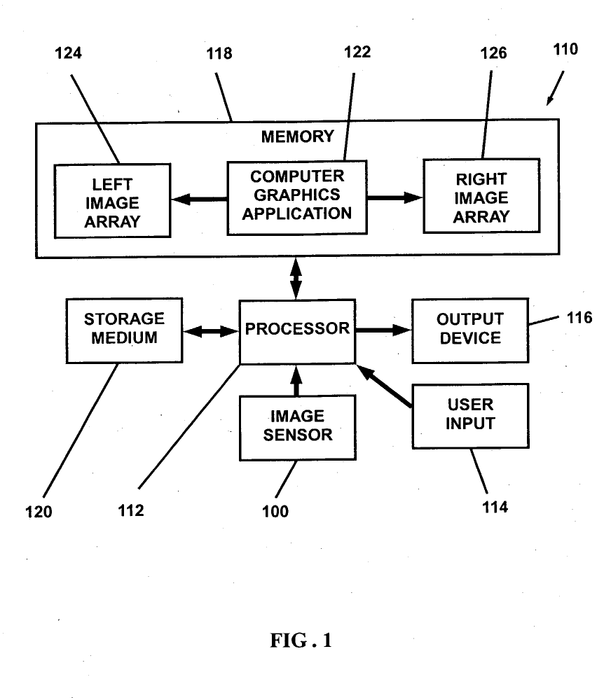

FIG. 1 shows a schematic diagram of a computer graphics system 110 used in accordance with the invention. Computer graphics system 110 comprises computer software running on a general purpose computer. Computer graphics system 110 comprises a processor 112, image sensor 100, user input device 114, output device 116, memory 118, and storage device 120.

The present invention comprises computer software that may be stored in memory 118 or on storage device 120 and is executed by processor 112. Storage device 120 may comprise a variety of types of storage media such as, for example, floppy disk drives, hard disk drives, CD ROM disk drives, DVD disk drives, or magnetic tape drives. Data may be received from the user of computer graphics system 110 using a keyboard, mouse, or any other type of input device 114. Data may be output to a user of computer graphics system 110 through output device 116. Output device 116 may comprise a variety of types of output devices such as, for example, a computer monitor, autostereoscopic display or a printer.

Computer graphics system 110 comprises computer graphics application 122, which is a computer software program for producing stereoscopic images on output device 116. In FIG. 1, computer graphics application 122 is illustrated as being stored in memory 118 for execution by processor 112. Computer graphics application 122 may also be stored in storage device 120. Computer graphics application 122 receives image data from sensor 100 and information from input device 114 and produces stereoscopic images on output device 116.

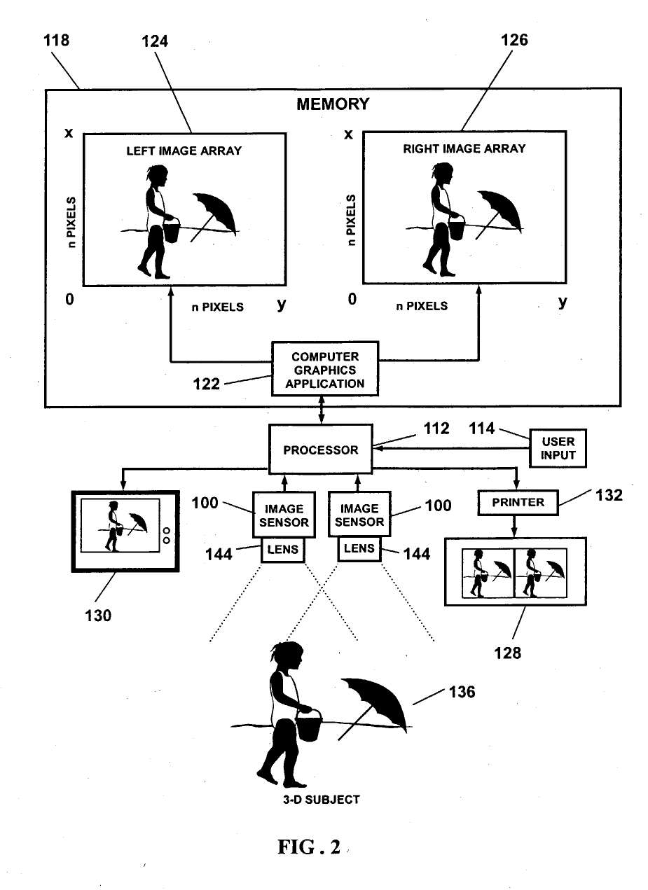

FIG. 2 shows a schematic of stereoscopic image processing computer graphics system 110 in block diagram form, further illustrating computer graphics application 122, processor 112, user input 114, and output devices 116 shown in FIG. 1. Capabilities are action methods, symbol methods, or any other function that allow the generation of information required to produce a graphical image. The computer graphics application 122 is a graphical image manipulator that, as discussed in greater detail below, is operable to access capabilities associated with pixel or image array processing to produce stereoscopic image output that is satisfactory for resolution by human vision. The acquisition of a stereoscopic image by sensors 100 through lenses 144 may comprise, as in this embodiment, two imaging devices for transmitting a discrete left image array 124 and discrete right image array 126 of 3-D subject 136. Left image array 124 and right image array 126 are sent by processor 112 to computer graphics application 122 which processes n number of pixels in the x and y dimensions of left image array 124 and right image array 126 in memory 118. Computer graphics application 122 allows user interaction with user input 114 to pass data to computer graphics application 122 to create, edit, render, modify, read or write left image array 124 and right image array 126. In this illustration the output device 116 comprises an autostereoscopic display 130 which allows, for example, a customer making a purchasing decision to preview the stereoscopic output on a screen without need of decoding eyewear and then order a formatted stereoscopic image print 128 produced by printer 132.

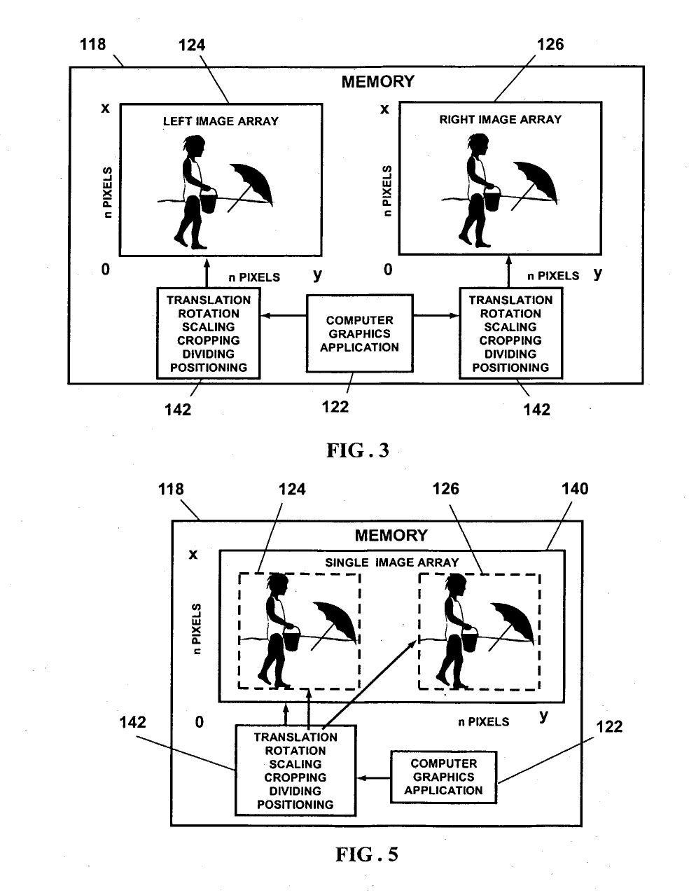

FIG. 3 shows a schematic of computer graphics application 122 and its transform or manipulating capabilities 142 interacting with left image array 124 and right image array 126. Computer graphics application 122 applies transform capabilities 142 to n number of pixels in the x and y dimensions of either or both left image array 124 and right image array 126 in memory 118. An example includes a method of image transform or manipulation where the user by way of user input 114 selects a pixel coordinate in left image array 124 and a pixel coordinate in right image array 126. This method allows for registering misaligned stereoscopic image pairs by identifying, for example, a new center-point around which new, identical x and y dimensioned frame boundaries can be established. Additionally, transform capabilities 142 provide a method, for example, of reassigning left or right position of left image array 124 and right image array 126 so as to reverse their relationship as a stereoscopic image pair. Additionally, these transform capabilities allow for positioning of x and y dimensions of left image array 124 and x and y dimensions of right image array 126 in relation to one another so that, for example, the proper interocular spacing of the two image arrays for output and subsequent viewing can be executed. The transform capabilities 142 can be initiated by user input 114 to computer graphics application 122 where each transform capability 142 can be discretely executed or a series of transform capabilities 142 executed by means of a single command. This capability allows for creating pre-set formats that can execute multiple image transforms actions required for satisfactory viewing on various stereoscopic output devices.

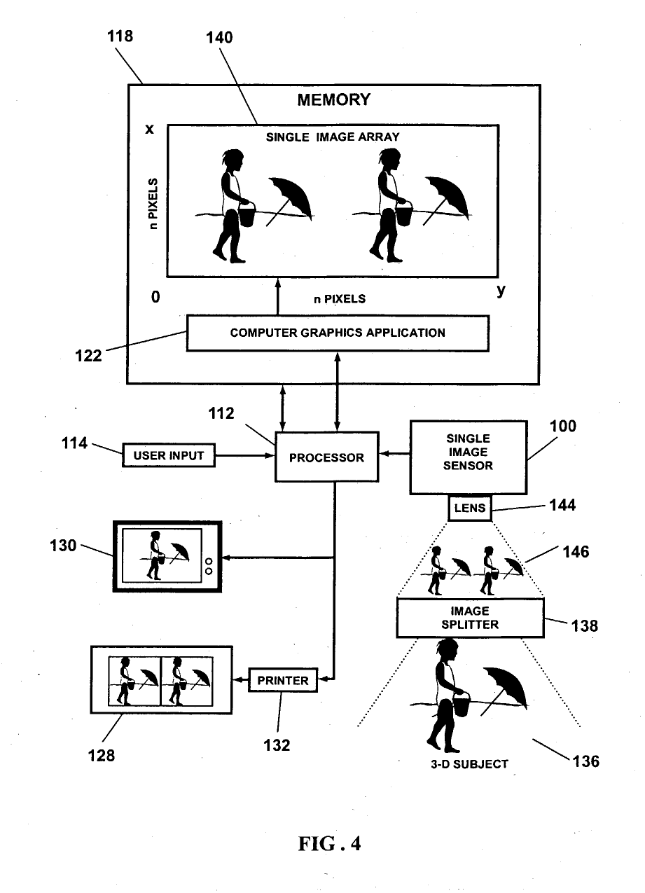

FIG. 4 illustrates a computer graphics system 110 wherein a stereoscopic image splitter 138 reflects left and right images 146 of 3-D subject 136 to one sensor 100 through a single lens 144. In this embodiment a single image array 140 is sent by processor 112 to computer graphics application 122 which processes n number of pixels in the x and y dimensions of image array 140 in memory 118. Computer graphics application 122 allows user interaction with user input 114 to pass data to computer graphics application 122 to create, edit, render, modify, read or write image array 140. In this illustration the output device 116 consists of autostereoscopic display 130 which allows, for example, a customer making a purchasing decision to preview the stereoscopic output without need of decoding eyewear and then order a formatted stereoscopic image print 128 produced by printer 132.

With reference to FIG. 5, if a user desires to create a stereoscopic image, he acquires the image by way of the sensor 100 fitted with image splitter 128 and makes an appropriate demand to the system 110 through input device 114 for the processor 112 to input image array 140 into computer graphics application 122 for processing. Subsequent demand by input device 114 may comprise, for example, clicking on a button in a graphical user interface with a mouse on a particular area of a computer screen to select a menu item specific to image splitter processing. In response to a request from input device 114, computer graphics application 122 determines that memory 118 contains a single image array 140 of n pixels in the x and y dimensions and image transform 112 vertically divides the array into two image arrays 144, comprising left and right images for further processing. The user by way of input device 114 is given an option to eliminate image artifacts in image arrays 144 associated with the overlap of mirrors in image splitter 128. The center points of the two image arrays 144 are calculated and the said arrays are aligned and positioned by image transform 142 in relation to one another so that specific output device 116, whether it be printer 132 or autostereoscopic monitor 130, can produce a stereoscopic image that can be satisfactorily resolved by human vision. If, for example, the combined x and y dimension pixel count of the two image arrays 144 exceed the output device requirement, the array is proportionately scaled to match that requirement.

With reference to FIG. 5, if a user desires to create a stereoscopic image, he acquires the image by way of the sensor 100 fitted with image splitter 128 and makes an appropriate demand to the system 110 through input device 114 for the processor 112 to input image array 140 into computer graphics application 122 for processing. Subsequent demand by input device 114 may comprise, for example, clicking on a button in a graphical user interface with a mouse on a particular area of a computer screen to select a menu item specific to image splitter processing. In response to a request from input device 114, computer graphics application 122 determines that memory 118 contains a single image array 140 of n pixels in the x and y dimensions and image transform 142 vertically divides the array into two image arrays 124 and 126 for further processing. The user by way of input device 114 is given an option to eliminate image artifacts in image arrays 144 associated with the overlap of mirrors in image splitter 138. The center points of the two image arrays 124 and 126 are calculated and the said arrays are aligned and positioned by image transform 142 in relation to one another so that specific output device 116, whether it be printer 132 or autostereoscopic monitor 130, can produce a stereoscopic image that can be satisfactorily resolved by human vision. If, for example, the combined x and y dimension pixel count of the two image arrays 144 exceed the output device requirement, the array is proportionately scaled to match that requirement.

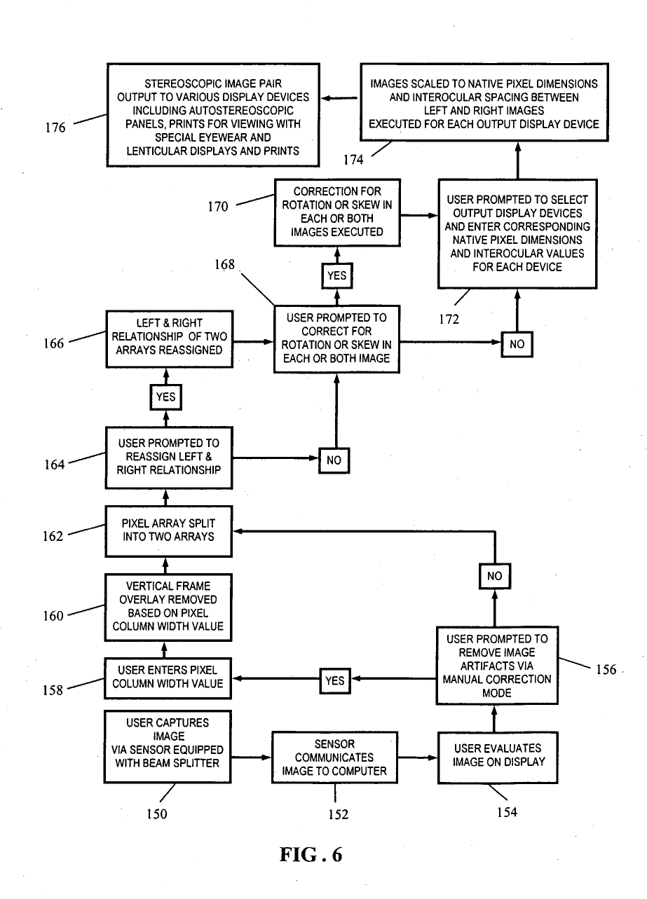

FIG. 6 shows a flowchart of a typical operation using the invention to acquire, process and output a stereoscopic image on a computer using a single image sensor 100. A user positions a subject at the appropriate distance in front of a single image sensor equipped with an image splitter in its optical path. The alignment of two primary mirrors and two secondary mirrors in the image splitter focuses a left image and right image of the subject into the single lenses of the image sensor. The user using a user input device selects a menu command or button on a graphical user interface to cause the computer program to signal the sensor to scan the subject 150. The acquired pixel array from the sensor is communicated to memory by the processor of a computer 152. The acquired pixel array in memory is communicated to an electronic display device such as a CRT or LCD for evaluation by the user 154. The image reflected by the image splitter appears on the display as two side-by-side images representing the left and right images of a stereoscopic view. Typical, however, are optical artifacts introduced by image slitters. This consists of an overlap of the left and right images at the center of the frame that has a disordered appearance. In addition, small misalignments of the primary and secondary mirrors can occur in manufacture of an image splitter and therefore create optical skews and perspective errors in the left and right views reflected to the sensor and, therefore, need to be corrected.

Thus, one method of the invention is to correct for the optical errors introduced by image splitters by means of a computer program that allows the user input device to select a menu command or button a a graphical user interface that activates a manual or automated correction mode. The manual correction mode illustrates the specific processing steps of the invention. In this embodiment the user by means of the user input device is prompted to select a menu command or button on a graphical user interface that communicates to the computer program a command to remove artifacts of the vertical overlap of the left and right images at the center of the frame caused by the image splitter 156. This command requires the user by way of the user input, typically a keyboard, to enter a value for the width of the pixel column to be removed at the center of the pixel array 158. The computer program communicates that value to the computer program that then applies an image transform consisting of a translation of the single pixel array into two pixel arrays of equal dimension 162 minus the value of the width of the pixel column at the center of the former single array 160. This translation is always applied to images acquired with an image splitter as the single pixel array must be split into two pixel arrays representing left and right stereoscopic data so that the interocular distance of the center points of the two pixel arrays can be assigned for the native pixel dimension of the output devices selected. Less typically, the user by way of the user input could select 168 to apply various transforms to each of both of the arrays by entering values to correct for rotation or skew caused by an image splitter or misaligned twin cameras that are used in image acquisition 170. Also, the user can choose to reassign the left and right relationship of the image arrays 164 for processing 166. However, this operation is more typically applied to images acquired with multiple cameras than with image splitters.

The value for the interocular distance of stereoscopic images viewed in one type of reflective print viewer can be different than another. Because the size of the output and the interocular orientations (i.e. side by side, over-under) of various view types require different proportional pixel dimensions before the interocular distance can be assigned, the computer program prompts the user to enter the native pixel dimensions of the displays on which the stereoscopic image will viewed 172 and the values of the appropriate interocular distance between the two arrays for the various output devices. The type of output and their associated dimensional values are communicated to the computer program which applies image transforms to make copies of the two pixel arrays in memory that comprise the stereoscopic image in equal number to the output devices requested. Transforms to scale each of the copies to the required pixel dimensions of each of the output devices is applied and the proper interocular distance between arrays is executed based upon the values entered 174 and the multiple stereoscopic outputs are displayed or printed 176. Thus, another advantage of the invention is that it provides for multiple formats of simultaneous output of a stereoscopic image.

The preferred embodiment of the invention is the automated correction mode whereby a script of pre-set actions and values performs the required processing for each of the image sensor types and output display devices. In this embodiment, the user enters the values associated with the characteristics of the cameras or image splitter and the various output display devices into the computer program and saves the data on a storage device for future use. In this embodiment, the user would activate the automated correction mode by using a input device, typically a single click of a mouse, on a menu command or button on a graphical user interface and the script of pre-set actions and values would be executed by the computer program.

Therefore, the invention provides a system for the acquisition, production and display of stereoscopic images that provides more precise image alignment, increased workflow speeds and delivery of multiple, specifically formatted output to various display devices. Furthermore, because the invention provides a program operable to process stereoscopic images, the invention allows the creation of pre-set formats that allows a single action by a user to execute multiple image transforms specific to the image acquisition device and output requirement. Thus, unlike conventional systems, the invention allows for an automated workflow resulting in faster customer service and less training of personnel.

Although several embodiments have been described in detail for purposes of illustration, various modifications may be made without departing from the scope and spirit of the invention. Accordingly, the invention is not to be limited, except as by the appended claims.

What is claimed is:

1. A process for creating stereoscopic images resolvable by human vision, the process comprising the steps of:
providing two images in at least one digital image array;
utilizing a computerized system to manipulate at least one of the images such that a stereoscopic effect is created that can be resolved by human vision; and
displaying the stereoscopic images.

2. The process of claim 1, including the step of utilizing an image sensor for acquiring the at least one digital image array.

3. The process of claim 2, wherein the image sensor comprises a plurality of image sensors positioned relative to one another to capture the images in the at least one digital image array.

4. The process of claim 2, including an image splitting device associated with the image sensor for creating left and right images in the digital image array.

5. The process of claim 2, including the step of electronically transferring the at least one digital image array acquired from the image sensor to a storage medium.

6. The process of claim 5, wherein the storage medium is operably connected to the computerized system for selective retrieval of the at least one digital image array.

7. The process of claim 1, wherein the manipulating step includes the step of splitting a single digital image array into two separate digital image arrays corresponding to left and right images.

8. The process of claim 1, wherein the manipulating step includes the step of aligning the images relative to one another to provide proper interocular spacing.

9. The process of claim 8, wherein the aligning step comprises the step of assigning pixel coordinates in each of the images.

10. The process of claim 8, wherein the aligning step comprises the step of establishing frame boundaries for each of the images.

11. The process of claim 8, wherein the aligning step comprises the step of assigning a left or right position to the two images.

12. The process of claim 8, wherein the aligning step comprises the step of establishing x and y dimensions to each image in relation to one another.

13. The process of claim 1, wherein the manipulating step includes the step of scaling or cropping at least one of the images.

14. The process of claim 1, wherein the manipulating step includes the step of rotating at least one of the images.

15. The process of claim 1, wherein the manipulating step includes the step of positioning at least one of the images.

16. The process of claim 1, wherein the manipulating step includes the step of dividing or copying at least one image to create duplicate images.

17. The process of claim 1, including the step of superimposing the images onto a stereoscopic background scene.

18. The process of claim 1, including the step of creating pre-set formats and manipulating the images to conform to the pre-set formats.

19. The process of claim 1, wherein the displaying step comprises the step of displaying the stereoscopic images on an electronic screen, or printing the stereoscopic images.

20. A process for creating stereoscopic images resolvable by human vision, the process comprising the steps of:
utilizing an image sensor for acquiring two images in at least one digital image array;
electronically transferring the at least one digital image array acquired from the image sensor to a storage medium;
utilizing a computerized system operably connected to the storage medium to selectively retrieve and manipulate at least one of the images, including assigning left and right positions to the images and aligning the images relative to one another to provide proper interocular spacing such that a stereoscopic effect is created that can be resolved by human vision; and
displaying the stereoscopic images on an electronic screen or printing the stereoscopic images.

21. The process of claim 20, wherein the image sensor comprises a plurality of image sensors positioned relative to one another to capture the images in the at least one digital image array.

22. The process of claim 120 including an image splitting device associated with the image sensor for creating left and right images in single digital image array, and including the step of splitting the single digital image array into two separate digital image arrays corresponding to left and right images.

23. The process of claim 20, wherein the aligning step comprises the step of assigning pixel coordinates in each of the images.

24. The process of claim 20, wherein the aligning step comprises the step of establishing frame boundaries for each of the images.

25. The process of claim 20, wherein the aligning step comprises the step of assigning a left or right position to the two images.

26. The process of claim 20, wherein the aligning step comprises the step of establishing x and y dimensions to each image in relation to one another.

25. The process of claim 20, wherein the manipulating step includes the step of scaling, cropping, rotating or positioning at least one of the images.

26. The process of claim 20, wherein the manipulating step includes the step of dividing or copying an image to create duplicate images.

27. The process of claim 20, including the step of superimposing the images onto a stereoscopic background scene.

28. The process of claim 20, including the step of creating pre-set formats and manipulating the images to conform to the pre-set formats.
